(19) United States
(12) Patent Application Publication
(10) Pub. No.: US 2017/0352182 A1
(43) Pub. Date: Dec. 7, 2017

(54) DYNAMIC LOW-RESOLUTION Z TEST SIZES

(71) Applicant: QUALCOMM Incorporated, San Diego, CA (US)

(72) Inventors: Tao Wang, Sunnyvale, CA (US); Xuefeng Tang, San Diego, CA (US); Jian Liang, San Diego, CA (US)

(21) Appl. No.: 15/174,110

(22) Filed: Jun. 6, 2016

(51) Int. Cl. G06T 15/30; G06T 15/40; G06T 15/00

(52) U.S. Cl. CPC G06T 15/30; G06T 15/005; G06T 15/405

(57) ABSTRACT

A graphics processing unit (GPU) may perform a binning pass to determine primitive-tile intersections for a plurality of primitives and a plurality of tiles making up a graphical scene, including performing low-resolution z-culling of representations of the plurality of primitives based at least in part on a first set of culling z-values each having a first test size to determine a first set of visible primitives from the plurality of primitives. The GPU may further perform a rendering pass to render the plurality of tiles based at least in part on performing the low-resolution z-culling of representations of the first set of visible primitives based at least in part on a second set of culling z-values that represents a second test size to determine a second set of visible primitives from the first set of visible primitives, wherein the first test size is greater than the second test size.

### TECHNICAL FIELD

This disclosure relates to graphics processing systems, and more particularly, to z-culling techniques for use in graphics processing systems.

### BACKGROUND

A graphics processing unit (GPU) may be used by various types of computing devices to accelerate the rendering of graphics data for display. Such computing devices may include, e.g., computer workstations, mobile phones (e.g., smartphones), embedded systems, personal computers, tablet computers, and video game consoles.

Rendering generally refers to the process of converting a three-dimensional (3D) graphics scene, which may include one or more 3D graphics objects, into two-dimensional (2D) rasterized image data. To render 3D graphics objects, a GPU may rasterize one or more primitives that correspond to each of the 3D graphics objects in order to generate a plurality of pixels that correspond to each of the 3D graphics objects. The pixels may be subsequently processed using various pixel processing operations to generate a resulting image. Pixel processing operations may include pixel shading operations, blending operations, texture-mapping operations, programmable pixel shader operations, etc.

As GPUs have become faster and faster, the complexity of graphics scenes that are rendered by GPUs has increased. Highly complex scenes may include a large number of 3D objects, each of which may correspond to hundreds or thousands of pixels. Processing each of these pixels may consume a significant amount of processing cycles and a relatively large amount of memory bandwidth.

3D graphics objects are typically subdivided into one or more graphics primitives (e.g., points, lines, triangles) prior to rasterization. Oftentimes, some of the primitives may block or occlude other primitives from the perspective of the viewport such that the occluded primitives may not be visible in the resulting rendered image. Performing pixel processing operations for the pixels of occluded primitives may result in performing unnecessary pixel operations, which may consume unnecessary processing cycles and memory bandwidth in a graphics processing system.

### SUMMARY

This disclosure describes techniques for performing low resolution z-culling in a graphics processing system. Z-culling is a technique by which a graphics processing unit (GPU) may determine which primitives are fully occluded by other primitives, and thus will not be visible, in the finally rendered scene. In some examples, low resolution z-culling may be performed both during a binning pass as well as a rendering pass of the graphics processing. Because the binning pass of graphics processing may have a relatively higher throughput than the rendering pass of graphics processing the GPU may perform low resolution z-culling using different low resolution z test sizes in the binning phase and the rending phase based on the low resolution z-culling throughput requirements for the two phases.

In one aspect, the disclosure is directed to a method. The method may include performing, by a graphics processing unit (GPU), a binning pass to determine primitive-tile intersections for a plurality of primitives of a graphical scene and a plurality of tiles making up the graphical scene, including performing low-resolution z-culling of representations of the plurality of primitives based at least in part on a first set of culling z-values each having a first test size to determine a first set of visible primitives from the plurality of primitives. The method may further include performing, by the GPU, a rendering pass to render the plurality of tiles based at least in part on performing the low-resolution z-culling of representations of the first set of visible primitives based at least in part on a second set of culling z-values that represents a second test size to determine a second set of visible primitives from the first set of visible primitives, wherein the first test size is greater than the second test size.

In another aspect, the disclosure is directed to a computing device. The computing device may include a memory. The computing device may further include at least one processor configured to: perform a binning pass to determine primitive-tile intersections for a plurality of primitives of a graphical scene and a plurality of tiles making up the graphical scene, including performing low-resolution z-culling of representations of the plurality of primitives based at least in part on a first set of culling z-values each having a first test size to determine a first set of visible primitives from the plurality of primitives; and perform a rendering pass to render the plurality of tiles based at least in part on performing the low-resolution z-culling of representations of the first set of visible primitives based at least in part on a second set of culling z-values that represents a second test size to determine a second set of visible primitives from the first set of visible primitives, wherein the first test size is greater than the second test size.

In another aspect, the disclosure is directed to an apparatus. The apparatus may include means for performing a binning pass to determine primitive-tile intersections for a plurality of primitives of a graphical scene and a plurality of tiles making up the graphical scene, including performing low-resolution z-culling of representations of the plurality of primitives based at least in part on a first set of culling z-values each having a first test size to determine a first set of visible primitives from the plurality of primitives. The apparatus may further include means for performing a rendering pass to render the plurality of tiles based at least in part on performing the low-resolution z-culling of representations of the first set of visible primitives based at least in part on a second set of culling z-values that represents a second test size to determine a second set of visible primitives from the first set of visible primitives, wherein the first test size is greater than the second test size.

In another aspect, the disclosure is directed to a computer-readable storage medium storing instructions that, when executed, cause at least one processor to: perform a binning pass to determine primitive-tile intersections for a plurality of primitives of a graphical scene and a plurality of tiles making up the graphical scene, including performing low-resolution z-culling of representations of the plurality of primitives based at least in part on a first set of culling z-values each having a first test size to determine a first set of visible primitives from the plurality of primitives; and perform a rendering pass to render the plurality of tiles based at least in part on performing the low-resolution z-culling of representations of the first set of visible primitives based at least in part on a second set of culling z-values that represents a second test size to determine a second set of visible primitives from the first set of visible primitives, wherein the first test size is greater than the second test size.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example computing device that may be configured to implement one or more aspects of this disclosure for utilizing dynamic low resolution Z test sizes.

FIG. 2 is a block diagram illustrating example implementations of the CPU, the GPU, and the system memory of FIG. 1 in further detail.

FIG. 3 is a block diagram illustrating an example of a simplified graphics processing pipeline that the GPU may perform during a binning pass.

FIG. 4 is a block diagram illustrating an example graphics processing pipeline that the GPU may perform during a rendering pass.

FIG. 5 is a flowchart illustrating example techniques for utilizing dynamic low resolution Z test sizes.

### DETAILED DESCRIPTION

A graphics processing unit (GPU) is often used to render a three dimensional scene. Because such rendering of three dimensional (3D) scenes can be memory bandwidth-intensive, a specialized graphics memory (GMEM) is located close to the graphics processing core of the GPU so that the specialized graphics memory has a high memory bandwidth. A scene can be rendered by the graphics processing core of the GPU to the GMEM, and the scene can be resolved from GMEM to memory (e.g., a frame buffer) so that the scene can then be displayed at a display device. However, because the size of the GMEM may be limited due to physical area constraints, the GMEM may not have sufficient memory capacity to contain an entire scene. Instead, a scene may to be split into tiles, so that each tile making up the scene can fit into GMEM. For example, if the GMEM is able to store 512 kB of data, then the scene may be divided into tiles such that the pixel data contained in each tile is less than or equal to 512 kB. In this way, the scene can be rendered by dividing up the scene into tiles that can be rendered into the GMEM and individually rendering each tile of the scene into the GMEM, storing the rendered tile from GMEM to a frame buffer, and repeating the rendering and storing for each tile of the scene. Accordingly, the scene can be rendered tile-by-tile to render each tile of the scene. This technique is sometimes called tile-based rendering and/or binning rendering.

Given a two-dimensional representation of a three-dimensional scene, the two dimensional representation may be divided into a plurality of tiles, where each tile may represent a block of pixels in the two-dimensional representation of the three-dimensional scene. In one example, a two-dimensional representation of a three-dimensional scene may have a resolution of 640×480, meaning that the two-dimensional representation may have a width of 640 pixels and a height of 480 pixels. If each of the plurality of tiles in this example has a height of 32 pixels and a width of 32 pixels, the two-dimensional representation may be divided into 300 tiles.

A scene can be made up of primitives, such as triangles. Because the two-dimensional representation of the three-dimensional scene may be divided into a plurality of tiles, some of the tiles making up the scene may possibly include one or more of the primitives. The tiles making up a scene can each be associated with a bin in memory that stores instructions for rendering the primitives included in each respective tile. Rendering a tile of the scene into the GMEM may include executing the instructions to render the primitives in the associated bin into the GMEM.

The GPU may perform a binning pass to divide a two-dimensional representation of a three-dimensional scene into tiles and to sort the primitives making up a scene into the appropriate tiles. Each of the tiles making up the scene may be associated with a respective bin in memory that stores commands that the GPU may execute to render the primitives included in the respective tile. The goal of the binning pass is to, for each of a plurality of tiles making up the scene, identify primitives that intersect the tile and/or is visible in the tile, and to store instructions for rendering those identified primitives into the bin associated with the tile. To that end, the GPU may perform a simplified version of a graphics processing pipeline (sometimes called a binning pipeline) to determine the positions of the vertices of the primitives in order to determine primitive-tile intersections. The binning pass may differ from a full-rendering pass in that only position information for vertices and pixels are used, and color information is not considered.

After performing the binning pass, the GPU may perform a rendering pass to render each of the tiles making up the two-dimensional representation of the three-dimensional scene. The GPU may, bin-by-bin, execute the commands stored in the respective bin to render the respective tile of the two-dimensional representation of the three-dimensional scene to GMEM, and to store the rendered tile from GMEM to a render target in memory, such as a frame buffer. To that end, the GPU may perform a full graphics processing pipeline to render the tiles making up the two-dimensional representation of the three-dimensional scene. In this way, the GPU may efficiently render a two-dimensional representation of a three-dimensional scene.

As part of the binning pass, the GPU may perform low resolution z-culling to determine whether primitives may be visible in the finally rendered scene, so that the GPU may refrain from performing a rendering pass for primitives that will not be visible in the finally rendered scene. Similarly, as part of the rendering pass, the GPU may also perform low-resolution z-culling to determine whether pixels may be visible in the finally rendered scene, based on whether z-values of pixels indicate it is relatively further away than another pixel in the same pixel location, so that the GPU may refrain from performing pixel operations for pixels that will not be visible in the finally rendered scene. In some examples, low resolution z-culling may also be called or may be similar to low resolution depth testing, hierarchical z-culling, hierarchical depth testing, coarse depth testing, and the like.

Low resolution z-culling refers to a technique whereby the GPU stores a culling z-value associated with a block of pixels. This is in contrast to z-culling where the GPU stores culling z-values associated with each individual pixel in the finally rendered scene. In other words, the GPU may utilize low resolution z-culling to reject blocks of pixels as not being visible in the finally rendered scene, while the GPU may utilize z-culling to reject individual pixels as not being visible in the finally rendered scene.

Because the GPU utilizes low resolution z-culling to reject blocks of pixels as opposed to individual pixels, the GPU may be able to determine the visibility of multiple pixels at a time versus determining the visibility of a single pixel at a time. As such, low resolution z-culling can have a relatively higher throughput than per-pixel z-culling in determining the visibility of pixels. Similarly, the GPU may also achieve higher throughput in determining the visibility of pixels by performing low resolution z-culling with culling z-values that are associated with a greater number of pixels versus performing low resolution z-culling with culling z-values that are associated with relatively fewer number of pixels.

As discussed above, when the GPU performs a binning pass, the GPU may perform a simplified version of the graphics processing pipeline. In contrast, when the GPU performs a rendering pass, the GPU may perform the full version of the graphics processing pipeline. Thus, the GPU may be able to sort primitives into the appropriate bins during the binning pass at a relatively higher rate than the GPU may be able to render primitives during the rendering pass. Given the difference in throughput between the binning pass and the rendering pass, and given that the GPU may perform low resolution z-culling as part of both the binning pass and the rendering pass, the GPU may perform low resolution z-culling during the binning pass in order to better match the high throughput of the binning pass, while also performing low resolution z-culling during the rending pass in order to better match the relatively lower throughput of the rendering pass.

In accordance with aspects of the present disclosure, the GPU may perform a binning pass to sort a plurality of primitives of a graphical scene into a plurality of tiles that make up the graphical scene, including performing low-resolution z-culling of representations of the plurality of primitives based at least in part on a first set of z-values that represents a first test size. The GPU may further perform a rendering pass to render one or more of the plurality of primitives based at least in part on performing the low-resolution z-culling of one or more representations of the one or more of the plurality of primitives based at least in part on a second set of z-values that represents a second test size, wherein the first test size is greater than the second test size. In this way, the GPU may perform low resolution z-culling using a relatively larger test size during the binning phase, so that the throughput of performing low resolution z-culling may be relatively high, to better match the relatively higher throughput of the binning pass. Conversely, the GPU may perform low resolution z-culling using a relatively smaller test size during the binning phase, so that the throughput of performing low resolution z-culling may be relatively low, to better match the relatively lower throughput of the rendering pass.

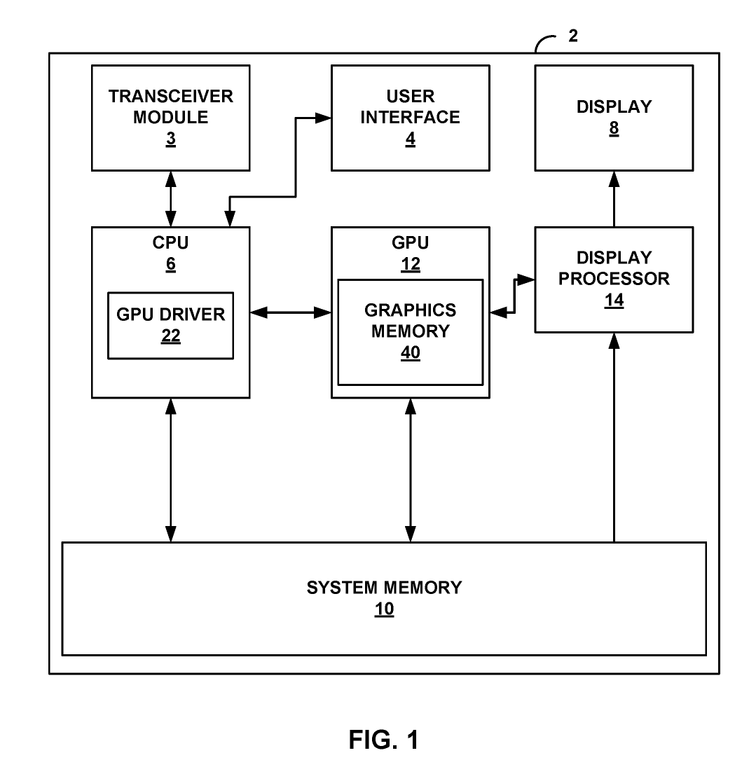

FIG. 1 is a block diagram illustrating an example computing device that may be configured to implement one or more aspects of this disclosure for utilizing dynamic low resolution Z test sizes. As shown in FIG. 1, computing device 2 may be a computing device including but not limited to video devices, media players, set-top boxes, wireless handsets such as mobile telephones and so-called smartphones, mobile phone handsets, wireless communication devices, personal digital assistants (PDAs), desktop computers, laptop computers, gaming consoles, video conferencing units, tablet computing devices, and the like. In the example of FIG. 1, computing device 2 may include central processing unit (CPU) 6, system memory 10, and GPU 12. Computing device 2 may also include display processor 14, transceiver module 3, user interface 4, and display 8. Transceiver module 3 and display processor 14 may both be part of the same integrated circuit (IC) as CPU 6 and/or GPU 12, may both be external to the IC or ICs that include CPU 6 and/or GPU 12, or may be formed in the IC that is external to the IC that includes CPU 6 and/or GPU 12.

Computing device 2 may include additional modules or units not shown in FIG. 1 for purposes of clarity. For example, computing device 2 may include a speaker and a microphone, neither of which are shown in FIG. 1, to effectuate telephonic communications in examples where computing device 2 is a mobile wireless telephone, or a speaker where computing device 2 is a media player. Computing device 2 may also include a video camera. Furthermore, the various modules and units shown in computing device 2 may not be necessary in every example of computing device 2. For example, user interface 4 and display 8 may be external to computing device 2 in examples where computing device 2 is a desktop computer or other device that is equipped to interface with an external user interface or display.

Examples of user interface 4 include, but are not limited to, a trackball, a mouse, a keyboard, and other types of input devices. User interface 4 may also be a touch screen and may be incorporated as a part of a display 8. Transceiver module 3 may include circuitry to allow wireless or wired communication between computing device 2 and another device or a network. Transceiver module 3 may include modulators, demodulators, amplifiers and other such circuitry for wired or wireless communication.

CPU 6 may be a microprocessor, such as a central processing unit (CPU) configured to process instructions of a computer program for execution. CPU 6 may comprise a general-purpose or a special-purpose processor that controls operation of computing device 2. A user may provide input to computing device 2 to cause CPU 6 to execute one or more software applications. The software applications that execute on CPU 6 may include, for example, an operating system, a word processor application, an email application, a spread sheet application, a media player application, a video game application, a graphical user interface application or another program. Additionally, CPU 6 may execute GPU driver 22 for controlling the operation of GPU 12. The user may provide input to computing device 2 via one or more input devices (not shown) such as a keyboard, a mouse, a microphone, a touch pad or another input device that is coupled to computing device 2 via user interface 4.

The software applications that execute on CPU 6 may include one or more graphics rendering instructions that instruct CPU 6 to cause the rendering of graphics data to display 8. In some examples, the software instructions may conform to a graphics application programming interface (API), such as, e.g., an Open Graphics Library (OpenGL®) API, an Open Graphics Library Embedded Systems (OpenGL ES) API, a Direct3D API, an X3D API, a RenderMan API, a WebGL API, or any other public or proprietary standard graphics API.

In order to process the graphics rendering instructions of the software applications, CPU 6 may issue one or more graphics rendering commands to GPU 12 (e.g., through GPU driver 22) to cause GPU 12 to perform some or all of the rendering of the graphics data. In some examples, the graphics data to be rendered may include a list of graphics primitives, e.g., points, lines, triangles, quadrilaterals, triangle strips, etc.

GPU 12 may be configured to perform graphics operations to render one or more graphics primitives to display 8. Thus, when one of the software applications executing on CPU 6 requires graphics processing, CPU 6 may provide graphics commands and graphics data to GPU 12 for rendering to display 8. The graphics data may include, e.g., drawing commands, state information, primitive information, texture information, etc. GPU 12 may, in some instances, be built with a highly-parallel structure that provides more efficient processing of complex graphic-related operations than CPU 6. For example, GPU 12 may include a plurality of processing elements, such as shader units, that are configured to operate on multiple vertices or pixels in a parallel manner. The highly parallel nature of GPU 12 may, in some instances, allow GPU 12 to draw graphics images (e.g., GUIs and two-dimensional (2D) and/or three-dimensional (3D) graphics scenes) onto display 8 more quickly than drawing the scenes directly to display 8 using CPU 6.

GPU 12 may, in some instances, be integrated into a motherboard of computing device 2. In other instances, GPU 12 may be present on a graphics card that is installed in a port in the motherboard of computing device 2 or may be otherwise incorporated within a peripheral device configured to interoperate with computing device 2. GPU 12 may include one or more processors, such as one or more microprocessors, application specific integrated circuits (ASICs), field programmable gate arrays (FPGAs), digital signal processors (DSPs), or other equivalent integrated or discrete logic circuitry. GPU 12 may also include one or more processor cores, so that GPU 12 may be referred to as a multi-core processor.

GPU 12 may be directly coupled to graphics memory 40. Thus, GPU 12 may read data from and write data to graphics memory 40 without using a bus. In other words, GPU 12 may process data locally using a local storage, instead of off-chip memory. Such graphics memory 40 may be referred to as on-chip memory. This allows GPU 12 to operate in a more efficient manner by eliminating the need of GPU 12 to read and write data via a bus, which may experience heavy bus traffic. In some instances, however, GPU 12 may not include a separate memory, but instead utilize system memory 10 via a bus. Graphics memory 40 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), Flash memory, a magnetic data media or an optical storage media.

In some examples, GPU 12 may store a fully formed image in system memory 10, where the image may be one or more surfaces. A surface, in some examples, may be a two dimensional block of pixels, where each of the pixels may have a color value. Throughout this disclosure, the term graphics data may, in a non-limiting example, include surfaces or portions of surfaces. Display processor 14 may retrieve the image from system memory 10 and output values that cause the pixels of display 8 to illuminate to display the image. Display 8 may be the display of computing device 2 that displays the image content generated by GPU 12. Display 8 may be a liquid crystal display (LCD), an organic light emitting diode display (OLED), a cathode ray tube (CRT) display, a plasma display, or another type of display device.

In accordance with aspects of the present disclosure, GPU 12 may perform a binning pass to sort a plurality of primitives of a graphical scene into a plurality of tiles that make up the graphical scene, including performing low-resolution z-culling of representations of the plurality of primitives based at least in part on a first set of z-values that represents a first test size. GPU 12 may further perform a rendering pass to render one or more of the plurality of primitives based at least in part on performing the low-resolution z-culling of one or more representations of the one or more of the plurality of primitives based at least in part on a second set of z-values that represents a second test size, wherein the first test size is greater than the second test size. In this way, GPU 12 may perform low resolution z-culling using a relatively larger test size during the binning phase, so that the throughput of performing low resolution z-culling may be relatively high to better match the relatively higher throughput of the binning pass. Conversely, GPU 12 may perform low resolution z-culling using a relatively smaller test size during the rendering phase, so that the throughput of performing low resolution z-culling may be relatively low, to better match the relatively lower throughput of the rendering pass.

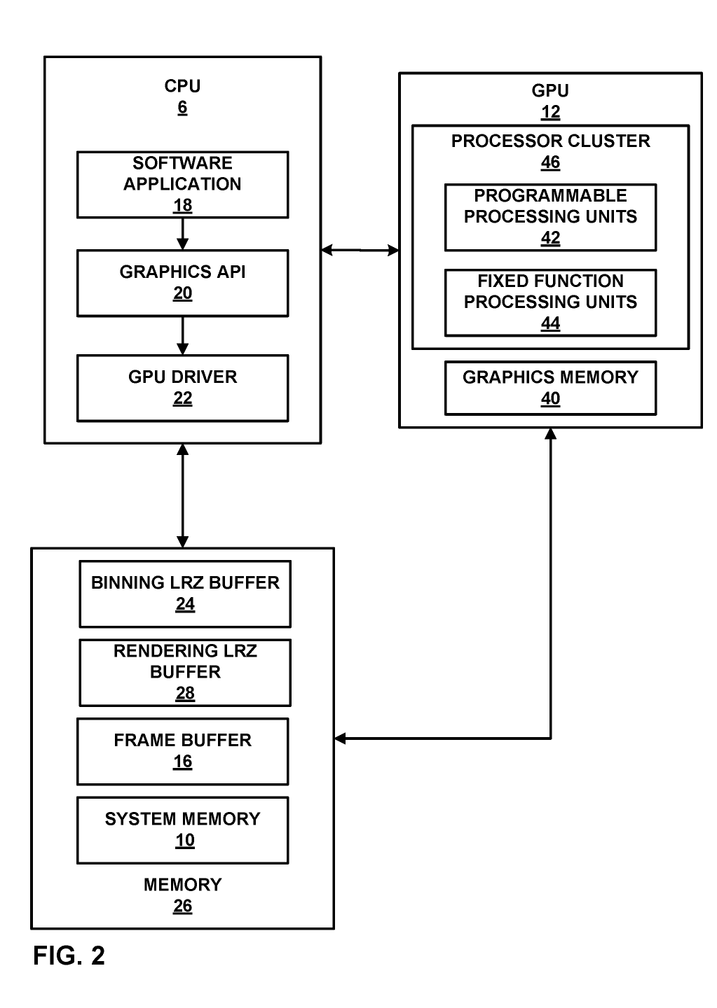

FIG. 2 is a block diagram illustrating example implementations of CPU 6, GPU 12, and system memory 10 of FIG. 1 in further detail. As shown in FIG. 2, CPU 6 may include at least one software application 18, graphics API 20, and GPU driver 22, each of which may be one or more software applications or services that execute on CPU 6.

Memory available to CPU 6 and GPU 12 may include system memory 10, frame buffer 16, binning LRZ buffer 24, and rendering LRZ buffer 28. Frame buffer 16 may be a part of system memory 10 or may be separate from system memory 10, and may store rendered image data. Similar to frame buffer 16, binning LRZ buffer 24 and rendering LRZ buffer 28 may be a part of system memory 10 or may be separate from system memory 10.

Software application 18 may be any application that utilizes the functionality of GPU 12. For example, software application 18 may be a GUI application, an operating system, a portable mapping application, a computer-aided design program for engineering or artistic applications, a video game application, or another type of software application that uses 2D or 3D graphics.

Software application 18 may include one or more drawing instructions that instruct GPU 12 to render a graphical user interface (GUI) and/or a graphics scene. For example, the drawing instructions may include instructions that define a set of one or more graphics primitives to be rendered by GPU 12. In some examples, the drawing instructions may, collectively, define all or part of a plurality of windowing surfaces used in a GUI. In additional examples, the drawing instructions may, collectively, define all or part of a graphics scene that includes one or more graphics objects within a model space or world space defined by the application.

Software application 18 may invoke GPU driver 22, via graphics API 20, to issue one or more commands to GPU 12 for rendering one or more graphics primitives into displayable graphics images. For example, software application 18 may invoke GPU driver 22, via graphics API 20, to provide primitive definitions to GPU 12. In some instances, the primitive definitions may be provided to GPU 12 in the form of a list of drawing primitives, e.g., triangles, rectangles, triangle fans, triangle strips, etc. The primitive definitions may include vertex specifications that specify one or more vertices associated with the primitives to be rendered. The vertex specifications may include positional coordinates for each vertex and, in some instances, other attributes associated with the vertex, such as, e.g., color coordinates, normal vectors, and texture coordinates. The primitive definitions may also include primitive type information (e.g., triangle, rectangle, triangle fan, triangle strip, etc.), scaling information, rotation information, and the like. Based on the instructions issued by software application 18 to GPU driver 22, GPU driver 22 may formulate one or more commands that specify one or more operations for GPU 12 to perform in order to render the primitive. When GPU 12 receives a command from CPU 6, processor cluster 46 may execute a graphics processing pipeline to decode the command and may configure the graphics processing pipeline to perform the operation specified in the command. For example, a command engine of the graphics processing pipeline may read primitive data and assemble the data into primitives for use by the other graphics pipeline stages in the graphics processing pipeline. After performing the specified operations, GPU 12 outputs the rendered data to frame buffer 16 associated with a display device.

Frame buffer 16 stores destination pixels for GPU 12. Each destination pixel may be associated with a unique screen pixel location. In some examples, frame buffer 16 may store color components and a destination alpha value for each destination pixel. For example, frame buffer 16 may store Red, Green, Blue, Alpha (RGBA) components for each pixel where the “RGB” components correspond to color values and the “A” component corresponds to a destination alpha value that indicates the transparency of the pixel. Frame buffer 16 may also store depth values for each destination pixel. In this way, frame buffer 16 may be said to store graphics data (e.g., a surface). Although frame buffer 16 and system memory 10 are illustrated as being separate memory units, in other examples, frame buffer 16 may be part of system memory 10. Once GPU 12 has rendered all of the pixels of a frame into frame buffer 16, frame buffer may output the finished frame to display 8 for display.

Processor cluster 46 may include one or more programmable processing units 42 and/or one or more fixed function processing units 44. In some examples, processor cluster 46 may perform the operations of a graphics processing pipeline. Programmable processing unit 42 may include, for example, programmable shader units that are configured to execute one or more shader programs that are downloaded onto GPU 12 from CPU 6. In some examples, programmable processing units 42 may be referred to as “shader processors” or “unified shaders,” and may perform geometry, vertex, pixel, or other shading operations to render graphics. The shader units may each include one or more components for fetching and decoding operations, one or more ALUs for carrying out arithmetic calculations, one or more memories, caches, and registers.

GPU 12 may designate programmable processing units 42 to perform a variety of shading operations such as vertex shading, hull shading, domain shading, geometry shading, fragment shading, and the like by sending commands to programmable processing units 42 to execute one or more of a vertex shader stage, tessellation stages, a geometry shader stage, a rasterization stage, and a fragment shader stage in the graphics processing pipeline. In some examples, GPU driver 22 may cause a compiler executing on CPU 6 to compile one or more shader programs, and to download the compiled shader programs onto programmable processing units 42 contained within GPU 12. The shader programs may be written in a high level shading language, such as, e.g., an OpenGL Shading Language (GLSL), a High Level Shading Language (HLSL), a C for Graphics (Cg) shading language, an OpenCL C kernel, etc. The compiled shader programs may include one or more instructions that control the operation of programmable processing units 42 within GPU 12. For example, the shader programs may include vertex shader programs that may be executed by programmable processing units 42 to perform the functions of the vertex shader stage, tessellation shader programs that may be executed by programmable processing units 42 to perform the functions of the tessellation stages, geometry shader programs that may be executed by programmable processing units 42 to perform the functions of the geometry shader stage, low resolution z-culling programs that may be executed by programmable processing units 42 to perform low resolution z-culling, and/or fragment shader programs that may be executed by programmable processing units 42 to perform the functions of the fragment shader stage. A vertex shader program may control the execution of a programmable vertex shader unit or a unified shader unit, and include instructions that specify one or more per-vertex operations.

Processor cluster 46 may also include fixed function processing units 44. Fixed function processing units 44 may include hardware that is hard-wired to perform certain functions. Although fixed function processing units 44 may be configurable, via one or more control signals for example, to perform different functions, the fixed function hardware typically does not include a program memory that is capable of receiving user-compiled programs. In some examples, fixed function processing units 44 in processor cluster 46 may include, for example, processing units that perform raster operations, such as, e.g., depth testing, scissors testing, alpha blending, low resolution depth testing, etc. to perform the functions of the rasterization stage of the graphics processing pipeline.

Graphics memory 40 is on-chip storage or memory that is physically integrated into the integrated circuit of GPU 12. In some instances, because graphics memory 40 is on-chip, GPU 12 may be able to read values from or write values to graphics memory 40 more quickly than reading values from or writing values to system memory 10 via a system bus.

In some examples, GPU 12 may operate according to a binning rendering mode to render graphics data (e.g., a graphical scene). When operating according to the deferred rendering mode, processor cluster 46 within GPU 12 first performs a binning pass (also known as a tiling pass) to divide a graphical frame into a plurality of tiles, and to determine which primitives intersect each of the tiles. For each of the plurality of tiles, processor cluster 46 then performs a rendering pass to render graphics data (color values of the pixels) of the tile to graphics memory 40 located locally on GPU 12, including performing a graphics processing pipeline to render each tile, and, when complete, reading the rendered graphics data from graphics memory 40 to a render target, such as frame buffer 16.

As part of both the binning pass and the rendering pass, GPU 12 may perform low resolution z-culling. During the binning pass, GPU 12 may perform low resolution z-culling to determine, for each primitive in the graphical scene, whether or not the particular primitive is visible in a rendered tile, and may generate a visibility stream that indicates whether each of the primitives may be visible in the finally rendered scene. If GPU 12 determines that the particular primitive will not be visible in a rendered tile, GPU 12 may refrain from performing a rendering pass to render the particular primitive. Similarly, during the rendering pass, GPU 12 may perform low resolution z-culling to determine, for a set of pixels, whether the particular set of pixels is visible in the rendered tile, and may refrain from performing pixel processing operations on the particular set of pixels if GPU 12 determines that they will not be visible in the rendered tile.

To perform low resolution z-culling, GPU 12 may divide the two-dimensional representation of the three-dimensional graphical scene into a plurality of blocks of pixels. GPU 12 may store, for each of the plurality of blocks of pixels, a culling z-value into the binning LRZ buffer 24 or rendering LRZ buffer 28. To initialize the culling z-value for a particular block of pixels, GPU 12 may receive a set of pixels corresponding to the particular block of pixels, along with the associated z-values for each pixel of the set of pixels, and may set the culling z-value for the particular block of pixels to the backmost z-value of the received set of pixels. The backmost z-value of the received set of pixels may be the z-value of the pixel that is furthest away from the camera out of the received set of pixels.

For example, for a culling z-value that is associated with a given 2×2 block of pixels (e.g., p00, p01, p10, and p11), GPU 12 may initially receive an incoming 2×2 block of pixels (e.g., p00′, p01′, p10′ and p11′) that correspond to the 2×2 block of pixels p00, p01, p10, and p11. Pixels p00′, p01′, p10′ and p11′ may have corresponding z-values of 0.2, 0.2, 0.1, and 0.15, respectively, where a higher value represents a depth that is further away from the camera than a lower value. To initiate the culling z-value for the 2×2 block of pixels p00, p01, p10, and p11, GPU 12 may set the culling z-value for that pixel block to be 0.2, because 0.2 is the backmost depth value of the four pixel values 0.2, 0.2, 0.1, and 0.15.

After initializing the culling z-values, GPU 12 may compare the nearest z-values of incoming blocks of pixels against the corresponding culling z-values. If the nearest z-value of an incoming block of pixels indicates it is farther from the camera than the culling z-value, GPU 12 may discard the incoming pixel block. Discarding an incoming pixel block may include, in the case of the binning pass, updating the visibility stream to indicate that the primitive represented by the pixel block may not be visible in the finally rendered scene, or, in the case of the rendering pass, not passing the incoming pixel block on to one or more subsequent pixel processing stages.

As can be seen, in some situations, GPU 12 may not discard incoming pixel blocks when GPU 12 performs low resolution z-culling, even if one or more pixels making up the representations of those primitives may be rejected during pixel-level depth testing of individual pixels.

As discussed above, in low resolution z-culling, as opposed to per-pixel z-culling, a culling z-value may be indicative of depth data for multiple pixels. A culling z-value may represent a pixel block having a test size, which may indicate the number of pixels in the pixel block that each culling z-value represents (e.g., the number of pixels represented by the corresponding culling z-value). Thus, the test size represented by a culling z-value for a 4×4 block of pixels may in some examples be 16, 4×4, or any other value to indicate the number of pixels in the 4×4 block of pixels that is represented by the culling z-value.

Because the throughput of GPU 12 while it performs the binning pass may differ from the throughput of GPU 12 while it performs the rendering pass, culling z-values stored in binning LRZ buffer 24 that are used during the binning pass may be associated with destination pixel blocks having a different test size than the test size of pixel blocks associated with the culling z-values stored in rendering LRZ buffer 28 that are used during the rendering pass.

Specifically, because GPU 12 may have a relatively higher throughput while performing the binning pass compared to the throughput of GPU 12 performing a rendering pass, culling z-values stored in binning LRZ buffer 24 may each be associated with pixel blocks having a relatively larger test size than the test size of pixel blocks associated with the culling z-values stored in rendering LRZ buffer 28 that are used during the rendering pass. In other words each culling z-value stored in binning LRZ buffer 24 that is used during the binning pass may be indicative of the depth of more associated pixels than culling z-values stored in rendering LRZ buffer 28 used during the rendering pass. In this way, the binning pass may utilize relatively larger test sizes to enable greater throughput in performing low resolution z-culling, while the rendering pass may utilize relatively smaller test sizes to discard more pixel blocks relative to utilizing relatively larger test sizes.

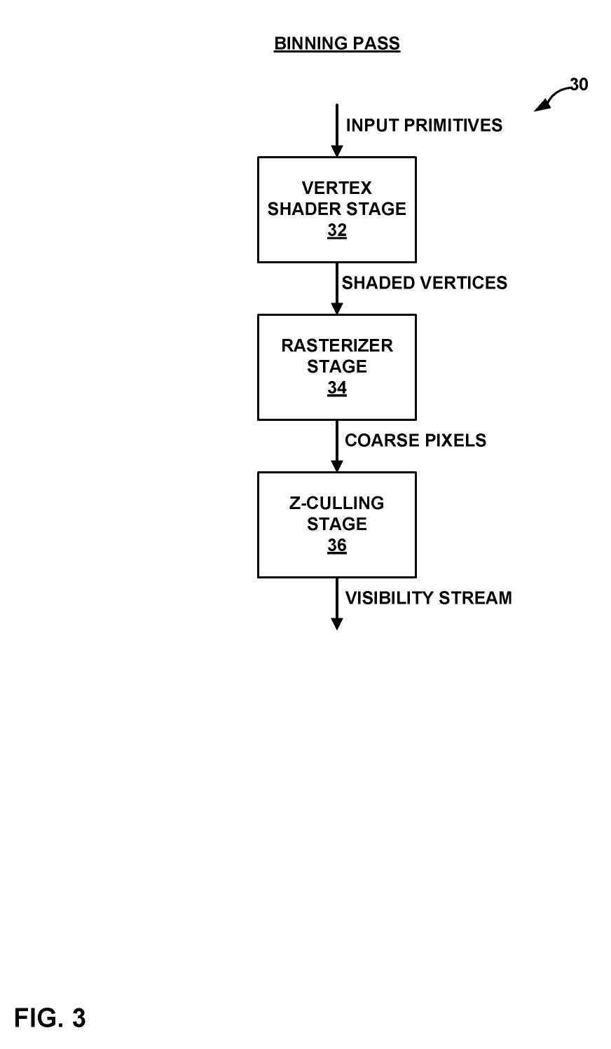

FIG. 3 is a block diagram illustrating an example of a simplified graphics processing pipeline 30 that GPU 12 may perform during a binning pass. As shown in FIG. 3, simplified graphics processing pipeline 30 may include vertex shader stage 32, rasterizer stage 34, and low resolution z-culling stage 36. Vertex shader stage 32 may be configured to operate as a simplified vertex shader that may only include instructions that affect the position of the vertices to perform per-vertex operations to produce shaded vertices. For example, color instructions, texture coordinates and other instructions that do not affect the position of primitive vertex may be removed from the simplified vertex shader stage 32. Further, unlike the rendering pass, GPU 12 may not perform pixel processing operations or pixel shading stages as part of the binning pass, and may not render a two-dimensional representation of the three-dimensional graphical scene into frame buffer 16.

GPU 12 may receive input primitives and may execute vertex shader stage 32 to produce shaded vertices. Input primitives may refer to primitives that are capable of being processed by the geometry processing stages of a graphics rendering pipeline. In some examples, input primitives may be defined by a graphics API that is implemented by graphics processing pipeline 50. For example, input primitives may correspond to the input primitive topologies in the Microsoft DirectX 11 API. Input primitives may include points, lines, line lists, triangles, triangle strips, patches etc. In some examples, the input primitives may correspond to a plurality of vertices that geometrically define the input primitives to be rendered.

GPU 12 may further execute vertex shader stage 32 to perform primitive-tile intersection tests to determine the tile (of a plurality of tiles) that intersects each particular input primitive. GPU 12 may, based on the results of the primitive-tile intersection tests, store primitive data for each primitive into the appropriate bin that is associated with the intersected tile. Such primitive data may include, in some instances, commands for rendering the primitive.

GPU 12 may perform a rasterizer stage 34 to generate, based on the shaded vertices produced by vertex shader stage 32, low-resolution representations of primitives (e.g, triangles) from the shaded vertices as coarse pixels. Thus, GPU 12 may perform rasterizer stage 34 to generate one or more pixels to represent primitives, where each pixel generated by the rasterizer stage may represent a multi-pixel area in the finally rendered scene. In one example, each pixel generated by rasterizer stage 34 may represent a 4×4 pixel area in the finally rendered scene. In other examples, each pixel generated by the rasterizer stage may represent a 2×2 pixel area, an 8×8 pixel area, and the like in the finally rendered scene.

GPU 12 may further generate per-bin visibility streams for each bin that indicates whether each of the primitives in the respective bin will be visible in the finally rendered scene. To generate the visibility streams, GPU 12 may perform low resolution z-culling stage 36 to determine which primitives will be visible in the finally rendered scene, and which primitives will not be visible in the finally rendered scene, such that GPU 12 may omit performance of a rendering pass to render those primitives based on the generated visibility streams. GPU 12 may determine, based at least in part on the depth (also known as a z-value) of the representations of primitives generated by the rasterizer, whether those primitives will be visible in the finally rendered scene, and may indicate in the visibility streams whether a particular primitive will be visible in the finally rendered scene. For example, each primitive may be associated with a bit in the visibility streams, and GPU 12 may set the corresponding bit in the visibility streams if GPU 12 determines that the respective primitive will be visible in the finally rendered scene. Similarly, GPU 12 may refrain from setting the corresponding bit in the visibility stream if GPU 12 determines that the respective primitive will not be visible in the finally rendered scene.

The test size represented by culling z-values may correspond to the pixel block size of the coarse pixels that are output by the rasterizer stage performed by GPU 12. As discussed above, GPU 12 may perform the rasterizer stage to generate one or more pixels to represent primitives, where each pixel generated by the rasterizer stage may represent a multi-pixel area in the finally rendered scene. A pixel generated by the rasterizer stage that represents a multi-pixel area may be referred to as a coarse pixel. In one example, each coarse pixel generated by the rasterizer stage may represent a 4×4 pixel area in the finally rendered scene. Thus a coarse pixel generated by the rasterizer stage may be a pixel that represents a block of pixels (e.g., two or more pixels), such as a 2×2 block of pixels, a 4×4 block of pixels, an 8×8 block of pixels, and the like.

The size of a coarse pixel generated by the rasterizer stage may correspond to or otherwise indicate the number of pixels represented by the coarse pixel. Thus the size of a coarse pixel that represents a 4×4 block of pixels may in some examples be 16, 4×4, or any other value to indicate the size of the coarse pixel that represents a 4×4 block of pixels. In one example, the test size represented by the culling z-values may be the same as the size of coarse pixels generated by the rasterizer stage. Thus, if each coarse pixel generated by the rasterizer stage represents a 4×4 block of pixels, each z-value may represent the depth value for a 4×4 block of pixels in the finally rendered scene.

In some examples, GPU 12 may determine the size of the coarse pixel based on the desired throughput of GPU 12, as utilizing relatively larger sized coarse pixels may enable GPU 12 to perform the operation herein more quickly (thereby improving GPU 12's throughput) compared with GPU 12 utilizing relatively smaller sized coarse pixels. For example, GPU 12 may utilize performance counters in various parts of GPU 12 to determine the number of primitives that are processed by GPU 12 over a period of time, to determine a throughput of GPU 12 utilizing currently-sized coarse pixels. GPU 12 may adjust the size of the coarse pixels for subsequent graphics processing to adjust the throughput of GPU 12, to increase or decrease subsequent throughput of GPU 12. Similarly, GPU 12 may adjust the test sizes represented by culling z-values in a similar fashion, by utilizing performance counters to determine the throughput of GPU 12, and adjusting the test sizes represented by the culling z-values to adjust the throughput of GPU 12.

In this example, because the test size represented by culling z-values may be the same as the size of coarse pixels generated by the rasterizer stage, GPU 12 may determine whether the primitive represented by a coarse pixel is visible in the finally rendered scene by comparing one or more z-values of the coarse pixel to the corresponding culling z-value for the corresponding pixel locations in the finally rendered scene. A coarse pixel may be associated with a max z-value and a min z-value. The max z-value may correspond to the z-value of the pixel within the block of pixels represented by the coarse pixel that is furthest from the camera. Correspondingly, the min z-value may correspond to the z-value of the pixel within the block of pixels represented by the coarse pixel that is closest to the camera. If the min z-value of the coarse pixel indicates that it is further from the camera than the corresponding culling z-value, then GPU 12 may update the corresponding visibility stream to indicate that the primitive represented by the coarse pixel is not visible in the finally rendered scene. On the other hand, if the min z-value of the coarse pixel indicates it is not further from the camera than the corresponding culling z-value, then GPU 12 may refrain from updating the corresponding visibility stream, to indicate that the primitive represented by the coarse pixel is visible in the finally rendered scene.

In addition, if the max z-value of the coarse pixel indicates that it is closer to the camera than the corresponding culling z-value, GPU 12 may update the corresponding visibility stream to indicate that the primitive represented by the coarse pixel may be visible in the finally rendered scene. Further, because the test size represented by the culling z-value is the same as the size of coarse pixels generated by the rasterizer stage, if the max z-value of the coarse pixel indicates that it is closer to the camera than the corresponding culling z-value, GPU 12 may also update the value of the corresponding culling z-value in binning LRZ buffer 24 with the max z-value of the particular coarse pixel to indicate that other potential coarse pixels that are farther away from the camera may be occluded by that particular coarse pixel.

In other examples, the test size represented by the culling z-values in binning LRZ buffer 24 may differ from the size of coarse pixels generated by the rasterizer stage 34. The test size represented by the culling z-values may be larger than or smaller than the size of coarse pixels generated by rasterizer stage 34. For instance, each coarse pixel generated by the rasterizer stage represents a 4×4 block of pixels, while the test size represented by the culling z-values may be associated with an 8×8 block of pixels.

GPU 12 may determine whether the primitive represented by a coarse pixel is visible in the finally rendered scene by comparing the min z-value of the coarse pixel to the corresponding culling z-value for the corresponding pixel locations in the finally rendered scene. If the min z-value of the coarse pixel indicates that it is further from the camera than the corresponding culling z-value, then GPU 12 may indicate in the visibility stream that the primitive represented by the coarse pixel is not visible in the finally rendered scene. On the other hand, if the max z-value of the coarse pixel indicates that it is closer to the camera than the corresponding culling z-value, GPU 12 may indicate in the visibility stream that the primitive represented by the coarse pixel may be visible in the finally rendered scene.

After completing the pass, GPU 12 may perform a rendering pass to render the scene as a two-dimensional image to graphics memory 40 based on the depth values stored in the low resolution buffer. Thus, the binning pass differs from the rendering pass at least because GPU 12, during the binning pass, does not render the two-dimensional representation of the scene.

In some examples, the techniques of the present disclosure may be equally applicable in a direct rendering mode. In the direct rendering mode, GPU 12 does not break a graphics frame into smaller bins. Instead, the entirety of a frame may be rendered at once. In these examples, in lieu of performing a binning pass, GPU 12 may perform a pre-z test prior to performing the rendering pass to render the scene. While performing the pre-z test, GPU 12 may generate culling z-values for blocks of pixels that GPU 12 may store into a buffer similar to binning LRZ buffer 24. For example, GPU 12 may perform a graphics processing pipeline to render only the z-values of a bounding box of a complex three-dimensional object, and may utilize culling z-values to determine whether portions of the object would be visible in the finally rendered scene.

Similar to the techniques described throughout this disclosure, when operating in the direct rendering mode, GPU 12 may, when performing earlier draw calls, build up an LRZ buffer having a relatively larger test size which GPU 12 may utilize to perform low resolution z-culling utilizing the z-culling. Later on, when GPU 12 performs later draw calls, GPU 12 may utilize the LRZ buffer built up during performing earlier draw calls to populate an LRZ buffer having a relatively smaller test size to perform finer-grained low resolution z-culling during these later draw calls. As such, the techniques described throughout this disclosure of performing low resolution z-culling using different low resolution z test sizes may equally be applicable while GPU 12 operates in a direct rendering mode.

To perform the rendering pass, GPU 12 may execute a graphics processing pipeline to, tile-by-tile, render the primitives that have been binned by the performance of the binning pass. After each tile is rendered to graphics memory 40, GPU 12 may transfer the rendered tile from graphics memory 40 to memory 26. In this way, frame buffer 16 or another render target may be filled tile-by-tile by rendered tiles from GPU 12, thereby rendering a surface into frame buffer 16 or another render target.

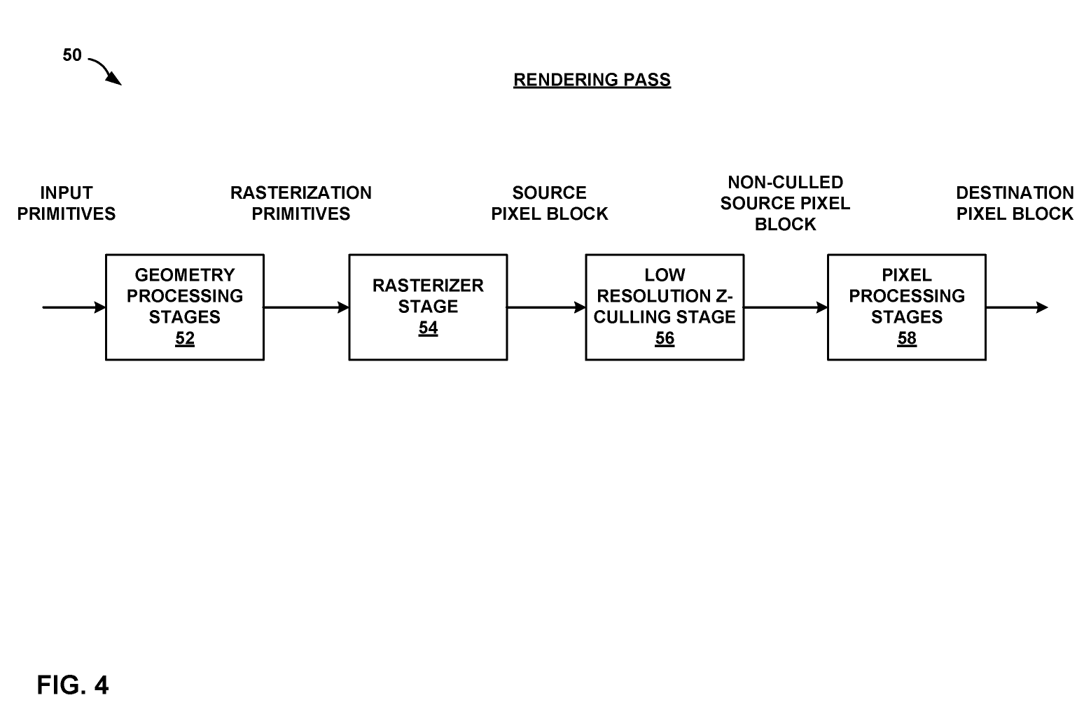

FIG. 4 is a block diagram illustrating an example graphics processing pipeline 50 that GPU 12 may perform during a rendering pass. When GPU 12 performs a rendering pass to render the primitives that it has identified as possibly being visible in the finally rendered scene, the GPU may render, tile-by-tile, the primitives that intersect the respective tile by processing the primitives through graphics processing pipeline 50. Graphics processing pipeline 50 includes one or more geometry processing stages 52, a rasterizer stage 54, a low resolution z-culling stage 56, and one or more pixel processing stages 58. In some examples, graphics processing pipeline 50 may be implemented in GPU 12 shown in FIG. 2. In such examples, geometry processing stages 52, rasterizer stage 54, low resolution z-culling stage 56, and pixel processing stages 58 may, in some examples, be implemented by processor cluster 46 of GPU 12.

Geometry processing stages 52 are configured to receive input primitives, and to generate rasterization primitives based on the input primitives. To generate the rasterization primitives, geometry processing stages 52 may perform geometry processing operations based the input primitives. Geometry processing operations may include, for example, vertex shading, vertex transformations, lighting, hardware tessellation, hull shading, domain shading, geometry shading, etc.

Input primitives may correspond to primitive data (e.g., commands to render the primitives) that GPU 12 stores into the appropriate bin during the binning pass according to the tile intersected by the respective input primitive.

Rasterization primitives may correspond to primitives that are capable of being processed by rasterizer stage 54. In some examples, the rasterization primitives may include points, lines, triangles, line streams, triangle streams, etc. In further examples, each input primitive may correspond to a plurality of rasterization primitives. For example, a patch may be tessellated into a plurality of rasterization primitives. In some examples, the rasterization primitives may correspond to a plurality of vertices that geometrically define the rasterization primitives to be rendered.

Rasterizer stage 54 is configured to receive rasterization primitives, and to generate one or more source pixel blocks based on the rasterization primitives. Each of the source pixel blocks may represent a rasterized version of the primitive at a respective one of a plurality of pixel block locations. For each of the rasterization primitives received, rasterizer stage 54 may rasterize the primitive to generate one or more source pixel blocks for the respective primitive.

A render target, such as frame buffer 16, may be subdivided into a plurality of tiles (e.g., regions) where each of the tiles contains a plurality of samples. A sample may refer to a pixel or, alternatively, to a sub-sample of a pixel. A pixel may refer to data that is associated with a particular sampling point in a set of sampling points for a rasterized image where the set of sampling points have the same resolution as the display. A sub-sample of a pixel may refer to data that is associated with a particular sampling point in a set of sampling points for a rasterized image where the set of sampling points have a resolution that is greater than the resolution of the display. The data associated with each of the samples may include, for example, one or more of color data (e.g., red, green, blue (RGB)), transparency data (e.g., alpha values), and depth data (e.g., z-values).

A destination sample may refer to a composited version of one or more source samples that have been processed for a particular sample location. A destination sample may correspond to sample data that is stored in a render target (e.g., a frame buffer or a binning buffer) for a particular sample location, and may be updated as each of the primitives in a scene is processed. A destination sample may include composited sample data from multiple source samples associated with different primitives. In contrast, a source sample may refer to sample data that is associated with a single geometric primitive and has not yet been composited with other source samples for the same sample location. A source sample may, in some examples, be generated by a rasterizer and processed by one or more pixel processing stages prior to being merged and/or composited with a corresponding destination sample.

Similarly, a destination pixel block may refer to a plurality of destination samples associated with a particular region of a render target. A destination pixel block may be a composited version of a plurality of source pixel blocks, each of which may correspond to a different primitive. A destination pixel block may be updated as each of the primitives in a scene is processed. A source pixel block may refer to a plurality of source samples associated with a particular region of a render target. A source pixel block may be associated with a single geometric primitive and has not yet been composited with other source pixel blocks for the same sample location. A source pixel block may, in some examples, be generated by a rasterizer and processed by one or more pixel processing stages prior to being merged and/or composited with a corresponding destination pixel block.

The samples in each of the source and destination pixel blocks may correspond to the samples of a region of a render target. The location of the region of the render target may be referred to as a pixel block location. Two pixel blocks that are associated with the same pixel block region may be referred to as co-located pixel blocks. In general, source pixel blocks that are not culled may be composited and/or merged into co-located destination pixel blocks.

To rasterize a primitive, rasterizer stage 54 may determine which pixel block locations of a render target are covered by the primitive, and generate a source pixel block for each of the pixel block locations that are covered by the primitive. A pixel block location may be covered by a primitive if the edges or interior of the primitive cover at least one of the samples associated with the pixel block location. A sample may be covered by a primitive if the area of the primitive includes the sample location.

Each of the source pixel blocks may include data indicative of a primitive that is sampled at a plurality of sampling points. The primitive that is indicated by the data included in a source pixel block may be the primitive that rasterizer stage 54 rasterized in order to generate the source pixel block, and may be said to correspond to the source pixel block. The sampling points at which the primitive is sampled may correspond to pixel block location of the source pixel block.

In some examples, for each of the source pixel blocks generated by rasterizer stage 54, rasterizer stage 54 may also generate one or more of the following: a coverage mask for the source pixel block, information indicative of whether the source pixel block is fully covered (i.e., completely covered), a conservative nearest z-value for the source pixel block, and a conservative farthest z-value for the source pixel block.

The coverage mask for the source pixel block may be indicative of which samples in the source pixel block are covered by the primitive that corresponds to the source pixel block. For example, the coverage mask may include a plurality of bits where each of the bits corresponds to a respective one of a plurality of samples in a source pixel block that corresponds to the coverage mask. The value of each of the bits may indicate whether a respective one of the samples in the source pixel block is covered by the primitive that corresponds to the source pixel block. For example, a value of “1” for a particular bit in the coverage mask may indicate that the sample corresponding to that bit is covered, while a value of “0” for the particular bit in the coverage mask may indicate that the sample corresponding to that bit is not covered.

The information indicative of whether the source pixel block is fully covered may indicate whether all of the samples in a source pixel block are covered by a primitive that corresponds to the source pixel block. In some examples, the information indicative of whether the source pixel block is fully covered may be one or more bits that equal one of two different values depending on whether all of the samples are covered. If all of the samples included in a source pixel block are covered by the primitive that corresponds to the source pixel block, then the source pixel block may be said to be fully covered. Otherwise, if less than all of the samples included in a source pixel block are covered by the primitive that corresponds to the source pixel block, then the source pixel block may be said to not be fully covered. If at least one of the samples in the source pixel block is covered by the primitive that corresponds to the source pixel block, but not all of the samples are covered, then the pixel block may be said to be a partially covered pixel block. In other words, a partially covered pixel block may refer to a pixel block that is not fully covered, but has at least one sample covered by the primitive that corresponds to the source pixel block.

The conservative nearest z-value for a source pixel block may refer to a value that is as near as or nearer than the nearest z-value for all of the covered samples in the source pixel block. In general, each of the samples in the source pixel block may have an associated z-value. The z-value for an individual sample in a pixel block may refer to a value indicative of the distance between the sample and a plane that is perpendicular to the direction of the camera (e.g., viewport) associated with a rendered graphics frame that includes the sample. The conservative nearest z-value for the source pixel block may be a value that is as near as or nearer than the z-value for the sample that is nearest to the camera associated with the rendered graphics frame. In some examples, the conservative nearest z-value for the source pixel block may be equal to the nearest z-value for the source pixel block. In this case, the conservative nearest z-value for the source pixel block may be referred to as the nearest z-value for the source pixel block. In some examples, if a smaller z-value indicates a sample that is relatively closer to the camera than a larger z-value, the nearest z-value for the source pixel block may be the smallest z-value for the source pixel block.

A conservative farthest z-value for a source pixel block may refer to a value that is as far as or farther than the farthest z-value for all of the covered samples in the source pixel block. In some examples, the conservative farthest z-value for the source pixel block may be equal to the farthest z-value for the source pixel block. In this case, the conservative farthest z-value for the source pixel block may be referred to as the farthest z-value for the source pixel block. In some examples, if a larger z-value indicates a sample that is relatively farther from the camera than a smaller z-value, the farthest z-value for the source pixel block may be the largest z-value for the source pixel block.

Different graphics systems may use different types of coordinate systems for generating z-values. Some graphics systems may generate z-values that increase with the distance that the sample is away from the camera. For such systems, whenever this disclosure refers to a nearest z-value or a conservative nearest z-value, such references may also be referred to as, respectively, a minimum z-value and a conservative minimum z-value. Similarly, for such systems, whenever this disclosure refers to a farthest z-value or a conservative farthest z-value, such references may also be referred to as, respectively, a maximum z-value and a conservative maximum z-value.

Other graphics systems may generate z-values that decrease with the distance that the sample is away from the camera. For such systems, whenever this disclosure refers to a nearest z-value or a conservative nearest z-value, such references may also be referred to as, respectively, a maximum z-value and a conservative maximum z-value. Similarly, for such systems, whenever this disclosure refers to a farthest z-value or a conservative farthest z-value, such references may also be referred to as, respectively, a minimum z-value and a conservative minimum z-value.

If this disclosure refers to a minimum or maximum z-value or a conservative minimum or maximum z-value, such z-values should be understood to be referring to minimum and maximum z-values within a particular z-coordinate system where z-values either increase or decrease with the distance away from the camera. It should be further understood that to implement the techniques of this disclosure with another z-coordinate system, then the roles of the references to minimum and maximum z-values may need to be interchanged. In general, if minimum or maximum z-values are referred to in this disclosure without specifying whether the z-coordinate system is an increasing or decreasing coordinate system, it should be understood that these z-values are referring to minimum or maximum z-values within an increasing z-coordinate system where the z-values increase as the distance away from the camera increases.

Low resolution z-culling stage 56 receives one or more source pixel blocks, a coverage mask for each of the source pixel blocks, information indicative of whether each of the source pixel blocks is fully covered, a conservative nearest z-value for each of the source pixel blocks, and a conservative farthest z-value for each of the source pixel blocks from rasterizer stage 54, and culls the source pixel blocks based on the received information to generate non-culled source pixel blocks, which include the pixels from the source pixel blocks that were not culled as a result of performing low resolution z-culling stage 56. The non-culled source pixel blocks are provided to pixel processing stages 58.

To generate the non-culled source pixel blocks, low resolution z-culling stage 56 may selectively discard from graphics processing pipeline 50 a source pixel block of samples associated with a pixel block location based on whether a conservative nearest z-value of the source pixel block is farther than a culling z-value associated with the pixel block location. The culling z-value may be indicative of a conservative farthest z-value for all samples of a destination pixel block that corresponds to the pixel block location. For example, low resolution z-culling stage 56 may discard a source pixel block in response to determining that the conservative nearest z-value of the source pixel block is farther than the culling z-value associated with the pixel block location, and not discard the source pixel block in response to determining that the conservative nearest z-value of the source pixel block is not farther than the culling z-value associated with the pixel block location.

Discarding a source pixel block may involve not passing the source pixel block on to one or more subsequent pixel processing stages 58. In other words, if a source pixel block is discarded, then low resolution z-culling stage 56 may not include the source pixel block in the set of non-culled (e.g., non-discarded) source pixel blocks. Not discarding the source pixel block may involve passing the source pixel block on to one or more subsequent pixel processing stages 58. In other words, if a source pixel block is not discarded, then low resolution z-culling stage 56 may include the source pixel block in the set of non-culled source pixel blocks.

Rendering LRZ buffer 28 may store a set of culling z-values. The set of culling z-values may include a culling z-value for each pixel block in a render target, such as frame buffer 16. Each of the culling z-values may be associated with one of a plurality of destination pixel blocks, and may indicate a conservative farthest z-value for all of the samples in the corresponding destination pixel block. A destination pixel block may correspond to a culling z-value if the pixel block location associated with the culling z-value is the same as the pixel block location for the destination pixel block.

It should be noted that, although the culling z-values may be indicative of conservative farthest z-values of corresponding destination pixel blocks, a destination pixel block may not actually be generated by low resolution z-culling stage 56. Instead, a destination pixel block may be generated by pixel processing stages 58 in graphics processing pipeline 50 and low resolution z-culling stage 56 may not necessarily have access to the actual destination pixel block. However, low resolution z-culling stage 56 may update the culling z-values in a manner that guarantees that the culling z-value will be at least as far as the farthest z-value in a destination pixel block that is subsequently generated by pixel processing stages 58.

Destination pixel blocks associated with culling z-values stored in rendering LRZ buffer 28 may each have the same test size. In other words, each of the destination pixel blocks may have the same dimensions (i.e., the same pixel width and pixel height). Thus, in some examples, each of the destination pixel blocks may be 2×2 pixel blocks, 4×4 pixel blocks, 8×8 pixel blocks, and the like.

GPU 12 may initialize culling z-values stored in rendering LRZ buffer 28 to be used while performing the rendering pass with culling z-values from binning LRZ buffer 24 utilized while performing the binning pass. GPU 12 may initially set each of the culling z-values stored in rendering LRZ buffer 28 to have the same value as the corresponding culling z-value stored in binning LRZ buffer 24. Specifically, for a set of culling z-values stored in rendering LRZ buffer 28 that correspond to the same pixel block locations in the finally rendered scene as a culling z-value stored in binning LRZ buffer 24, each culling z-value of that set of culling z-values in rendering LRZ buffer 28 may be set to the same value as the corresponding culling z-value stored in binning LRZ buffer 24. Thus, in one example, given a culling z-value stored in binning LRZ buffer 24 that corresponds to pixel locations p00 to p15 (e.g., a 4×4 block of pixels) in the finally rendered scene, each culling z-value in a set of culling z-values in rendering LRZ buffer 28 may each be set to the value of that culling z-value stored in binning LRZ buffer 24, where the set of culling z-values stored in rendering LRZ buffer 28 includes a culling z-value that corresponds to pixel locations p00 to p03 (e.g., a 2×2 block of pixels), a culling z-value that corresponds to pixel locations p04 to p07, a culling z-value that corresponds to pixel locations p08 to p11, and a culling z-value that corresponds to pixel locations p12 to p15.

Low resolution z-culling stage 56 may update a culling z-value for a pixel block location based on one or more of a coverage mask associated with a source pixel block corresponding to the pixel block location, information indicative of whether the source pixel block is fully covered, a conservative farthest z-value for the source pixel block, a conservative nearest z-value for the source pixel block, and a culling z-value for the pixel block location. Each time a source pixel block is processed by low resolution z-culling stage 56, low resolution z-culling stage 56 may determine whether a culling z-value for a pixel block location that corresponds to the source pixel block is to be updated. In some examples, if low resolution z-culling stage 56 determines that the source pixel block is to be discarded, then low resolution z-culling stage 56 may determine that the culling z-value is not to be updated. If low resolution z-culling stage 56 determines that the source pixel block is not to be discarded, then low resolution z-culling stage 56 may determine whether the culling z-value for the pixel block location corresponding to the source pixel block is to be updated using one or more techniques depending on whether the source pixel block is fully covered or partially covered.

For a fully-covered source pixel block, low resolution z-culling stage 56 may determine whether a conservative farthest z-value for the source pixel block is nearer than the culling z-value for the pixel block location that corresponds to the source pixel block. If the conservative farthest z-value for the source pixel block is nearer than the culling z-value, then low resolution z-culling stage 56 may set the culling z-value equal to the conservative farthest z-value for the source pixel block. If the conservative farthest z-value for the source pixel block is not nearer than the culling z-value, then low resolution z-culling stage 56 may maintain the previous culling z-value (i.e., not update the culling z-value).

Pixel processing stages 58 may receive the non-culled source pixel blocks (e.g., source pixel blocks that GPU 12 determines may be visible in the finally rendered scene) from low resolution z-culling stage 56 and perform pixel processing on the non-culled source pixel blocks to generate destination pixel blocks. Pixel processing may include, for example, pixel shading operations, blending operations, texture-mapping operations, programmable pixel shader operations, etc. In some examples, some or all of pixel processing stages 58 may process the samples in a source pixel block together. In further examples, some or all of pixel processing stages 58 may process each of the samples in a source pixel block independently of each other. In some examples, pixel processing stages 58 may include an output merger stage that merges or composites a source pixel block into a co-located destination pixel block (i.e., a destination pixel block that has the same location as the source pixel block). In some cases, the destination pixel block generated by pixel processing stages 58 may be placed into a render target (e.g., a frame buffer). Performing pixel processing may include performing detailed z-culling on individual pixels of the non-culled source pixel blocks. For example, pixel processing stages 58 may include hardware and/or processing units that execute software that is configured to test the z-value of a pixel against the z-value stored in the depth buffer at that fragment's sample position. If pixel processing stages 58 determines, based on performing the detailed z-culling, that a pixel will be occluded from view in the finally rendered scene behind another pixel, then GPU 12 may discard the pixel and may cease further processing of the pixel.

In some examples, GPU 12 may refrain from performing low resolution z-culling stage 56 during the rendering pass. Instead, GPU 12 may perform the techniques similar to that of low resolution z-culling stage 56 in a separate z-culling pass after performing the binning pass shown in FIG. 3 and prior to performing the rendering pass shown in FIG. 4. Further, in some examples, GPU 12 may perform low-resolution z-culling based at least in part on a first set of culling z-values each having a first test size, and subsequently performing low-resolution z-culling based at least in part on a second set of culling z-values each having a second test size as described throughout this disclosure outside of the context of binning passes, rendering passes, and the like. For example, an application running on CPU 6 and/or GPU 12 may perform a first low-resolution z-culling similar to the techniques for performing low resolution z-culling stage 36 during the binning pass, as shown in FIG. 3, and may subsequently perform a second low-resolution z-culling similar to the techniques for performing low resolution z-culling stage 56 during the rendering pass, as shown in FIG. 4. In other words, the z-culling techniques described throughout this disclosure may not be limited to binning passes and rendering passes, but may be equally applicable outside of the context of binning passes, rendering passes, and the like.

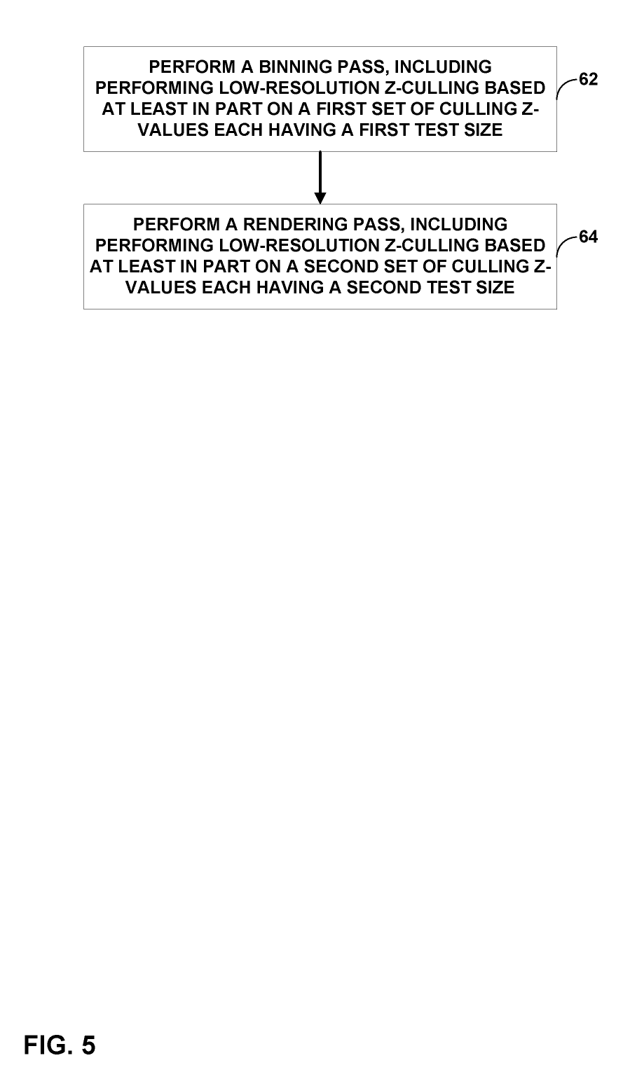

FIG. 5 is a flowchart illustrating example techniques for utilizing dynamic low resolution Z test sizes. As shown in FIG. 5, GPU 12 may perform a binning pass to determine primitive-tile intersections for a plurality of primitives of a graphical scene and a plurality of tiles making up the graphical scene, including performing low-resolution z-culling of representations of the plurality of primitives based at least in part on a first set of culling z-values each having a first test size to determine a first set of visible primitives from the plurality of primitives (62). GPU 12 may further perform a rendering pass to render the plurality of tiles based at least in part on performing the low-resolution z-culling of representations of the first set of visible primitives based at least in part on a second set of culling z-values that represents a second test size to determine a second set of visible primitives from the first set of visible primitives, wherein the first test size is greater than the second test size (64).

In some examples, the first set of culling z-values comprises a first set of depth values for a first set of pixel blocks each having the first test size, and the second set of culling z-values comprises a second set of depth values for a second set of pixel blocks each having the second test size.

In some examples, GPU 12 may store the first set of culling z-values into a binning LRZ buffer 24 and may store the second set of culling z-values into a rendering LRZ buffer 28, wherein the second set of culling z-values comprises a greater number of culling z-values than the first set of culling z-values. In some examples, GPU 12 may initialize the second set of culling z-values using the first set of z-values.

In some examples, initializing the second set of culling z-values using the first set of culling z-values further comprises GPU 12 initializing a plurality of culling z-values of the second set of culling z-values that correspond to a pixel block location with a corresponding culling z-value of the first set of culling z-values that correspond to the pixel block location. In some examples, initializing the second set of culling z-values using the first set of culling z-values further comprises GPU 12 storing each culling z-value from the first set of culling z-values into a plurality of storage locations within the rendering LRZ buffer 28.

In some examples, GPU 12 may render representations of the second set of visible primitives to a frame buffer 16.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry such as discrete hardware that performs processing.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware, firmware, and/or software components, or integrated within common or separate hardware or software components.

The techniques described in this disclosure may also be stored, embodied or encoded in a computer-readable medium, such as a computer-readable storage medium that stores instructions. Instructions embedded or encoded in a computer-readable medium may cause one or more processors to perform the techniques described herein, e.g., when the instructions are executed by the one or more processors. In some examples, the computer-readable medium may be a non-transitory computer-readable storage medium. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable storage media that is tangible.

Computer-readable media may include computer-readable storage media, which corresponds to a tangible storage medium, such as those listed above. Computer-readable media may also comprise communication media including any medium that facilitates transfer of a computer program from one place to another, e.g., according to a communication protocol. In this manner, the phrase “computer-readable media” generally may correspond to (1) tangible computer-readable storage media which is non-transitory, and (2) a non-tangible computer-readable communication medium such as a transitory signal or carrier wave.

Various embodiments of the invention have been described. These and other embodiments are within the scope of the following claims.

What is claimed is:

1. A method comprising:
performing, by a graphics processing unit (GPU), a binning pass to determine primitive-tile intersections for a plurality of primitives of a graphical scene and a plurality of tiles making up the graphical scene, including performing low-resolution z-culling of representations of the plurality of primitives based at least in part on a first set of culling z-values each having a first test size to determine a first set of visible primitives from the plurality of primitives; and
performing, by the GPU, a rendering pass to render the plurality of tiles based at least in part on performing the low-resolution z-culling of representations of the first set of visible primitives based at least in part on a second set of culling z-values that represents a second test size to determine a second set of visible primitives from the first set of visible primitives, wherein the first test size is greater than the second test size.

2. The method of claim 1, wherein the first set of culling z-values comprises a first set of depth values for a first set of pixel blocks each having the first test size, and wherein the second set of culling z-values comprises a second set of depth values for a second set of pixel blocks each having the second test size.

3. The method of claim 1, further comprising:
storing, by the GPU, the first set of culling z-values into a binning low resolution z (LRZ) buffer; and
storing, by the GPU, the second set of culling z-values into a rendering LRZ buffer, wherein the second set of culling z-values comprises a greater number of culling z-values than the first set of culling z-values.

4. The method of claim 3, further comprising:
initializing, by the GPU, the second set of culling z-values using the first set of z-values.

5. The method of claim 4, wherein initializing the second set of culling z-values using the first set of culling z-values further comprises:
initializing, by the GPU, a plurality of culling z-values of the second set of culling z-values that correspond to a pixel block location with a corresponding culling z-value of the first set of culling z-values that correspond to the pixel block location.

6. The method of claim 4, wherein initializing the second set of culling z-values using the first set of culling z-values further comprises:
storing, by the GPU, each culling z-value from the first set of culling z-values into a plurality of storage locations within the rendering LRZ buffer.

7. The method of claim 1, further comprising:
rendering, by the GPU, representations of the second set of visible primitives to a frame buffer.

8. A computing device comprising:
a memory; and
at least one processor configured to:
perform a binning pass to determine primitive-tile intersections for a plurality of primitives of a graphical scene and a plurality of tiles making up the graphical scene, including performing low-resolution z-culling of representations of the plurality of primitives based at least in part on a first set of culling z-values each having a first test size to determine a first set of visible primitives from the plurality of primitives; and
perform a rendering pass to render the plurality of tiles based at least in part on performing the low-resolution z-culling of representations of the first set of visible primitives based at least in part on a second set of culling z-values that represents a second test size to determine a second set of visible primitives from the first set of visible primitives, wherein the first test size is greater than the second test size.

9. The computing device of claim 8, wherein the first set of culling z-values comprises a first set of depth values for a first set of pixel blocks each having the first test size, and wherein the second set of culling z-values comprises a second set of depth values for a second set of pixel blocks each having the second test size.

10. The computing device of claim 8, wherein the at least one processor is further configured to:
store the first set of culling z-values into a binning low resolution z (LRZ) buffer in the memory; and
store the second set of culling z-values into a rendering LRZ buffer in the memory, wherein the second set of culling z-values comprises a greater number of culling z-values than the first set of culling z-values.

11. The computing device of claim 10, wherein the at least one processor is further configured to:
initialize the second set of culling z-values using the first set of z-values.

12. The computing device of claim 11, wherein the at least one processor is further configured to:
initialize a plurality of culling z-values of the second set of culling z-values that correspond to a pixel block location with a corresponding culling z-value of the first set of culling z-values that correspond to the pixel block location.

13. The computing device of claim 11, wherein the at least one processor is further configured to:
store each culling z-value from the first set of culling z-values into a plurality of storage locations within the rendering LRZ buffer.

14. The computing device of claim 8, wherein the at least one processor is further configured to:
render representations of the second set of visible primitives to a frame buffer.

15. The computing device of claim 8, wherein the computing device comprises a wireless communication device.

16. The computing device of claim 8, wherein the computing device comprises a mobile phone handset.

17. An apparatus comprising:
means for performing a binning pass to determine primitive-tile intersections for a plurality of primitives of a graphical scene and a plurality of tiles making up the graphical scene, including performing low-resolution z-culling of representations of the plurality of primitives based at least in part on a first set of culling z-values each having a first test size to determine a first set of visible primitives from the plurality of primitives; and
means for performing a rendering pass to render the plurality of tiles based at least in part on performing the low-resolution z-culling of representations of the first set of visible primitives based at least in part on a second set of culling z-values that represents a second test size to determine a second set of visible primitives from the first set of visible primitives, wherein the first test size is greater than the second test size.

18. The apparatus of claim 17, wherein the first set of culling z-values comprises a first set of depth values for a first set of pixel blocks each having the first test size, and wherein the second set of culling z-values comprises a second set of depth values for a second set of pixel blocks each having the second test size.

19. The apparatus of claim 17, further comprising:
means for storing the first set of culling z-values into a binning low resolution z (LRZ) buffer; and
means for storing the second set of culling z-values into a rendering LRZ buffer, wherein the second set of culling z-values comprises a greater number of culling z-values than the first set of culling z-values.

20. The apparatus of claim 19, further comprising:
means for initializing the second set of culling z-values using the first set of z-values.

21. The apparatus of claim 20, wherein the means for initializing the second set of culling z-values using the first set of culling z-values further comprises:
means for initializing a plurality of culling z-values of the second set of culling z-values that correspond to a pixel block location with a corresponding culling z-value of the first set of culling z-values that correspond to the pixel block location.

22. The apparatus of claim 20, wherein the means for initializing the second set of culling z-values using the first set of culling z-values further comprises:
means for storing each culling z-value from the first set of culling z-values into a plurality of storage locations within the rendering LRZ buffer.

23. The apparatus of claim 17, further comprising:
means for rendering representations of the second set of visible primitives to a frame buffer.

24. A computer-readable storage medium storing instructions that, when executed, cause at least one processor to:
perform a binning pass to determine primitive-tile intersections for a plurality of primitives of a graphical scene and a plurality of tiles making up the graphical scene, including performing low-resolution z-culling of representations of the plurality of primitives based at least in part on a first set of culling z-values each having a first test size to determine a first set of visible primitives from the plurality of primitives; and
perform a rendering pass to render the plurality of tiles based at least in part on performing the low-resolution z-culling of representations of the first set of visible primitives based at least in part on a second set of culling z-values that represents a second test size to determine a second set of visible primitives from the first set of visible primitives, wherein the first test size is greater than the second test size.

25. The computer-readable storage medium of claim 24, wherein the first set of culling z-values comprises a first set of depth values for a first set of pixel blocks each having the first test size, and wherein the second set of culling z-values comprises a second set of depth values for a second set of pixel blocks each having the second test size.

26. The computer-readable storage medium of claim 24, wherein the instructions further cause the at least one processor to:
store the first set of culling z-values into a binning low resolution z (LRZ) buffer in memory; and
store the second set of culling z-values into a rendering LRZ buffer in the memory, wherein the second set of culling z-values comprises a greater number of culling z-values than the first set of culling z-values.

27. The computer-readable storage medium of claim 26, wherein the instructions further cause the at least one processor to:
initialize the second set of culling z-values using the first set of z-values.

28. The computer-readable storage medium of claim 27, wherein the instructions further cause the at least one processor to:
initialize a plurality of culling z-values of the second set of culling z-values that correspond to a pixel block location with a corresponding culling z-value of the first set of culling z-values that correspond to the pixel block location.

29. The computer-readable storage medium of claim 27, wherein the instructions further cause the at least one processor to:
store each culling z-value from the first set of culling z-values into a plurality of storage locations within the rendering LRZ buffer.

30. The computer-readable storage medium of claim 24, wherein the instructions further cause the at least one processor to:
render representations of the second set of visible primitives to a frame buffer.
